(19) United States
(12) Patent Application Publication
(10) Pub. No.: US 2022/0143557 A1
(43) Pub. Date: May 12, 2022

(54) METHOD OF FILTRATION, METHOD OF DESALINATING SEA WATER, METHOD OF PRODUCING FRESH WATER, HOLLOW FIBER MEMBRANE MODULE, AND SEA WATER DESALINATION SYSTEM

(71) Applicant: ASAHI KASEI KABUSHIKI KAISHA, Chiyoda-ku, Tokyo (JP)

(72) Inventor: Kohei NAKAMOTO, Chiyoda-ku, Tokyo (JP)

(73) Assignee: ASAHI KASEI KABUSHIKI KAISHA, Chiyoda-ku, Tokyo (JP)

(21) Appl. No.: 17/593,091

(22) PCT Filed: Mar. 12, 2020
(86) PCT No.: PCT/JP2020/010788

§ 371 Date: Sep. 9, 2021

(30) Foreign Application Priority Data
Mar. 12, 2019 (JP) 2019-045203

(51) Int. Cl. B01D 63/04; C02F 1/44; B01D 61/58; B01D 63/02

(52) U.S. Cl. CPC B01D 63/04; C02F 1/441; C02F 2103/08; B01D 61/58; B01D 63/023; C02F 1/444

(57) ABSTRACT

A method of a filtration uses a hollow fiber membrane module comprising a module case; and a hollow fiber membrane bundle comprising a plurality of hollow fiber membranes bundled together and being accommodated in the module case, respective ends of the hollow fiber membranes being bonded together by a potting material. The filtration is carried out in the hollow fiber membrane module under a pressure of 0.3 to 1.2 MPa. The hollow fiber membrane module satisfies a relationship: 0.5<R/L<5 when the pressure inside the hollow fiber membrane module is 1.0 MPa without the hollow fiber membrane module being restrained, and satisfies relationships: 0<R<0.25 and 0<L<0.06 during an operation in an operation condition, where R (%) represents a radial expansion ratio at a center portion in a longitudinal direction, and L (%) represents a longitudinal expansion ratio, of the hollow fiber membrane module.

### CROSS-REFERENCE OF RELATED APPLICATION

This application claims priority to Japanese Patent Application No. 2019-45203, filed Mar. 12, 2019, the entire disclosure of which is incorporated herein by reference.

### TECHNICAL FIELD

The present disclosure relates to a method of filtration, a method of desalinating sea water, and a method of producing fresh water, which use a fiber membrane module, the hollow fiber membrane module, and a sea water desalination system, the fiber membrane module comprising a hollow fiber membrane bundle comprising a plurality of hollow fiber membranes bundled together, particularly to those having an increased pressure resistance.

### BACKGROUND

In applications of gas-liquid absorption, deaeration, filtration, and the like, hollow fiber membranes have been well known as membranes for membrane filtrations utilizing microfiltration membranes or ultrafiltration membranes. Membrane modules comprising hollow fiber membranes have larger membrane areas, thereby enabling size reductions of the systems, and have been widely used in a variety of applications of membrane separations. As one type of such membrane modules, modules are known which comprise a hollow fiber membrane bundle comprising a plurality of hollow fiber membranes having respective ends bonded together with a resin.

Filtrations employing hollow fiber membrane modules are roughly classified into internal pressure filtrations, in which raw water permeates from the inner surface sides to the outer surface sides of hollow fiber membranes to obtain filtrate water, and external pressure filtrations, in which raw water permeates from the outer surface sides to the inner surface sides.

During a filtration operation, a positive pressure is exerted externally from the inside of a module case having a hollow fiber membrane bundle accommodated therein. Thus, the module case is required to have a pressure resistance sufficient to withstand under the operating conditions. In some filtration applications, module cases are required to have a high pressure resistance.

As an example, a high pressure resistance may be required in applications of sea water desalination. In sea water desalination, microfiltration and ultrafiltration membranes are used as pre-treatment filters. Typically, a buffer tank is provided between a pre-treatment filter and a reverse osmosis membrane filter used for a desalting process. In recent years, however, for reducing the footprints of systems and amounts of chemical agents used in a buffer tank, there has been a demand for desalting systems in which a pre-treatment filter and a reverse osmosis filter are directly connected, without a buffer tank interposed therebetween. In such a configuration, in order to ensure that a high pressure can be applied to a reverse osmosis membrane, a pressure resistance higher than those of conventional filtrations has been demanded in module cases of pre-treatment filters.

In the meantime, hollow fiber membrane modules have been used in systems for producing ultra-pure water which remove impurities, such as salts, organic substances, gases, and fine particles, to the utmost limits, as final filters. Unlike sea water desalination processes, frequent cleaning processes are not carried out in an ultra-pure water manufacturing subsystem. Instead, a high creeping characteristic is required because a pressure of about 1 MPa at maximum is applied on a hollow fiber membrane module for a long time. Enhancing the pressure resistance of a hollow fiber membrane module by integrating it with a module case is known in which a material with a higher elastic modulus, such as resins containing glass short fibers, is used as the material of the case (see PTL 1). Further, a housing for accommodating a cartridge-type membrane module is known which is fabricated by winding glass long fibers and a matrix resin on a mandrel that serves as a mold, curing the matrix resin completely, removing the resultant product from the mold, and machining the product to finish a housing (see PTL 2).

### CITATION LIST

### Patent Literature

PTL 1: JP2009-160561A

PTL 2: JP2013-117250A

### SUMMARY

### Technical Problem

Even when a resin containing glass fibers is used, however, the walls of the pipes are required to be thickened depending on the conditions for filter operations. There are two options of increasing the thicknesses of pipes: increasing them inwardly or increasing them outwardly. Increasing thicknesses inwardly reduces the filtration areas, which may result in reduced performances of products. On the other hand, the filtration area can be maintained by increasing thicknesses outwardly, but dies are needed for respective pipes, incurring an enormous capital investment.

As disclosed in PTL 2, pressure resistances in the circumferential and radial directions can be controlled to a certain degree by adjusting the winding angle of glass fibers. In the approach disclosed in PTL 2, however, glass fibers may be exposed to an inner surface of a housing, which contacts ultra-pure water, making the housing unsuitable due to possible elution. In addition, both a hollow fiber membrane module and a spiral module housing may be provided with side ports for discharging a filtrate or concentrate. In a hollow fiber membrane module integrated with a case, sufficient space is needed near the side port, for permitting flow of a filtrate or a washing liquid between the inner surface of the case and the outer circumference of a hollow fiber membrane bundle. In addition, a flow guide cylinder for controlling the flow of a liquid near the nozzle may be provided. Thus, pipes and heads of a housing are typically formed as separate parts, which are later bonded together. In manufacturing method such as one in PTL 2, a product is manufactured by winding around a mandrel. However, since the product must be removed from the mandrel afterward, a housing having a varied diameter in the longitudinal direction is difficult to be fabricated.

In systems for pre-treatment for sea water desalination, polyethylene or polyvinyl chloride is often used as the main material for pipes for the reasons of costs and durability. In ultra-pure water production subsystems, pipes made of fluorine-based material pipes are often used for the reasons of the anti-elution characteristic and heat resistance. In cases where such plastic pipes are used, it has been found that longitudinal expansions or contractions of a hollow fiber membrane module resultant from pressure fluctuations due to various operating conditions exert loads greater than as expected, not only on the membrane module but also on connected pipes.

In order to carry out filtration operations for as a long time as possible, a sea water desalination pre-treatment system may adopt a process known as “reverse washing”, in which liquid is forced for a short time to flow backward, i.e., from the secondary side to the primary side, during a filtration, in order to remove substances trapped in the membranes. Reverse washing is carried out at a frequency of once for a few minutes to dozens of minutes, depending on the type of a liquid to be filtrated. Since a filtration module is used repeatedly for a long time, it is subjected to a considerable number of repetitive pressure fluctuations. Ultra-pure water produced by an ultra-pure water production subsystem is ultimately used in points of use in a clean room. Conventionally, since the proportion of the amount of water used at points of use was small relative to the water production capacity of a ultra-pure water production subsystem, the pressure fluctuation due to supply of ultra-pure water to the point of use was slight. However, in recent years, the proportion of use of ultra-pure water at points of use has increased for the reasons of the cost efficiency and reduction in the environmental impact. There is a challenge in that the degree and frequency of pressure fluctuations in an ultra-pure water production subsystem are increased as usage and frequency of ultra-pure water increase.

### Solution to Problem

We have diligently studied and found that the aforementioned challenge could be solved by balancing the radial expansion ratio and the longitudinal expansion ratio of a housing against a pressure applied on a hollow fiber membrane module, thereby completing the present disclosure. Specifically, the present disclosure is as follows:
[1] A method of a filtration by using a hollow fiber membrane module comprising a module case; and a hollow fiber membrane bundle comprising a plurality of hollow fiber membranes bundled together and being accommodated in the module case, respective ends of the hollow fiber membranes being bonded together by a potting material, the filtration being carried out under a pressure inside the hollow fiber membrane module of 0.3 to 1.2 MPa,

wherein the hollow fiber membrane module satisfies a relationship: 0.5<R/L<5 when the pressure inside the hollow fiber membrane module is 1.0 MPa without the hollow fiber membrane module being restrained, and

the hollow fiber membrane module satisfies relationships: 0<R<0.25 and 0<L<0.06 during an operation, where R (%) represents a radial expansion ratio at a center portion in a longitudinal direction, and L (%) represents a longitudinal expansion ratio, of the hollow fiber membrane module.
[2] A method of desalinating sea water by using a hollow fiber membrane module comprising a module case; and a hollow fiber membrane bundle comprising a plurality of hollow fiber membranes bundled together and being accommodated in the module case, respective ends of the hollow fiber membranes being bonded together by a potting material, under a pressure inside the hollow fiber membrane module of 0.3 to 1.2 MPa, the method comprising:

a filtration step of filtrating the sea water through the hollow fiber membrane module; and

a desalting step of desalting a filtrate from the filtration step, through a reverse osmosis membrane directly connected to the hollow fiber membrane module, under a pressure higher than a pressure in the filtration step,

wherein the hollow fiber membrane module satisfies a relationship: 0.5<R/L<5 when the pressure inside the hollow fiber membrane module is 1.0 MPa without the hollow fiber membrane module being restrained, and

the hollow fiber membrane module satisfies relationships: 0<R<0.25 and 0<L<0.06 during an operation in an operation condition, where R (%) represents a radial expansion ratio at a center portion in a longitudinal direction, and L (%) represents a longitudinal expansion ratio, of the hollow fiber membrane module.
[3] A method of producing fresh water by using a hollow fiber membrane module comprising a module case; and a hollow fiber membrane bundle comprising a plurality of hollow fiber membranes bundled together and being accommodated in the module case, respective ends of the hollow fiber membranes being bonded together by a potting material, under a pressure inside the hollow fiber membrane module of 0.3 to 1.2 MPa, the method comprising:

a filtration step of filtrating a raw liquid through the hollow fiber membrane module; and

a desalting step of desalting a filtrate from the filtration step, through a reverse osmosis membrane directly connected to the hollow fiber membrane module, under a pressure higher than a pressure in the filtration step,

wherein the hollow fiber membrane module satisfies a relationship: 0.5<R/L<5 when the pressure inside the hollow fiber membrane module is 1.0 MPa without the hollow fiber membrane module being restrained, and

the hollow fiber membrane module satisfies relationships: 0<R<0.25 and 0<L<0.06 during an operation in an operation condition, where R (%) represents a radial expansion ratio at a center portion in a longitudinal direction, and L (%) represents a longitudinal expansion ratio, of the hollow fiber membrane module.
[4] The method of filtration of [1], comprising a filtration step of feeding a raw water at 70° C. or higher and 80° C. or lower to outer surface sides of the hollow fiber membranes, with a differential pressure across the membranes of 0.3 MPa at maximum under a pressure of 0.8 MPa at maximum, to extract a filtrate from inner surface sides of the hollow fiber membranes under a pressure of 0.8 MPa at maximum.
[5] The method of filtration of [1], comprising a filtration step of feeding the raw water at 20° C. or higher and 30° C. or lower to the outer surface sides of the hollow fiber membranes, with a differential pressure across the membranes of 0.3 MPa at maximum under a pressure of 1.2 MPa at maximum, to extract the filtrate under a pressure of 1.2 MPa at maximum.
[6] A hollow fiber membrane module comprising:

a module case; and

a hollow fiber membrane bundle comprising a plurality of hollow fiber membranes bundled together and being accommodated in the module case, respective ends of the hollow fiber membranes being bonded together by a potting material,

wherein the hollow fiber membrane module satisfies a relationship: 0.5<R/L<5 when the pressure inside the hollow fiber membrane module is 1.0 MPa without the hollow fiber membrane module being restrained, and

the hollow fiber membrane module satisfies relationships: 0<R<0.25 and 0<L<0.06 during an operation, where R (%) represents a radial expansion ratio at a center portion in a longitudinal direction, and L (%) represents a longitudinal expansion ratio, of the hollow fiber membrane module.
[7] The hollow fiber membrane module according to [6], wherein the module case comprises:

a header made of a plastic material containing glass short fibers; and

a columnar part comprising an inner layer of a plastic part and an outer layer of a glass fiber reinforced resin part containing glass long fibers, the glass long fibers being wound in the glass fiber reinforced resin part at an angle of 60° to 120° relative to a tubular axial direction of the module case.
[8] The hollow fiber membrane module according to [6] or [7], wherein at least a part of the module case comprises a layer of a glass fiber reinforced resin part on an outer surface side thereof, and a ratio of a thickness of the layer of the glass fiber reinforced resin part to a wall thickness of the module case is 5% or more and 50% or less, in at least a part of the module case provided with the glass fiber reinforced resin part.
[9] The hollow fiber membrane module according to any one of [6] to [8], wherein

at least a part of the module case includes at least one of a glass cloth, a roving cloth, and a chopped strand mat, and

a weight per square meter of the at least one of the glass cloth, the roving cloth, and the chopped strand mat is 50 g or more and 600 g or less.
[10] The hollow fiber membrane module according to [8], wherein

the glass fiber reinforced resin part comprises a first glass fiber reinforced resin part covering a columnar part, a second glass fiber reinforced resin part covering a header, and a third glass fiber reinforced resin part covering a nozzle,

a region in which glass fibers in the first glass fiber reinforced resin part and glass fibers in the second glass fiber reinforced resin part overlap one another, and

a region in which glass fibers in the second glass fiber reinforced resin part and glass fibers in the third glass fiber reinforced resin part overlap one another.
[11] The hollow fiber membrane module according to [10], wherein a weight per square meter of the at least one of the glass cloth, the roving cloth, and the chopped strand mat of the glass fibers used in the third glass fiber reinforced resin part is 50 g or more and 300 g or less.
[12] The hollow fiber membrane module according to any one of [8], [10], and [11], wherein

the glass fiber reinforced resin part is laminated on an outer surface side of the plastic part in the module case, and

a tensile shear strength of the glass fiber reinforced resin part and the plastic part is 3 MPa or more.
[13] The hollow fiber membrane module according to any one of [8] and [10] to [12], wherein

the at least one of the glass cloth, the roving cloth, and the chopped strand mat containing the glass fibers in the glass fiber reinforced resin part is wound spirally in the module case, and

a width of the at least one of the glass cloth, the roving cloth, and the chopped strand mat is 30 mm or more and 140 mm or less.
[14] A sea water desalination system comprising:

the hollow fiber membrane module according to any one of [6] to [13], configured to filtrate sea water; and

a reverse osmosis membrane module configured to desalt a filtrate from the hollow fiber membrane module, the hollow fiber membrane module and the reverse osmosis membrane module being directly connected or being connected having a pump interposed therebetween.

### Advantageous Effect

According to the present disclosure, provided are a method of filtration, a sea water desalination method, and a fresh water produce method, which use a hollow fiber membrane module, the hollow fiber membrane module, and a sea water desalination system, the hollow fiber membrane module having an excellent practicality and enabling stable and long-term filtration operations under high pressures and being subjected to pressure fluctuations while adopting an operation system and an operating method enabling stable and long-term operations of the filtration system.

### BRIEF DESCRIPTION OF THE DRAWINGS

In the accompanying drawings:

FIG. 1 is a vertical cross-sectional view illustrating a hollow fiber membrane module according to one embodiment of the present disclosure;

FIG. 2 is a vertical cross-sectional view illustrating a modification to the hollow fiber membrane module in FIG. 1;

FIG. 3 is a cross-sectional view of a glass fiber containing part of the module case in FIG. 1;

FIG. 4 is a cross-sectional view of the glass fiber containing part covering the outer circumferential surface of the plastic part of the module case in FIG. 1;

FIG. 5 illustrates the tilt of glass fibers inside the module case in FIG. 1;

FIG. 6 illustrates winding of a fabric body of glass fibers inside the module case in FIG. 1;

FIG. 7 illustrates one form of a glass cloth for covering a nozzle;

FIG. 8 is a configuration diagram illustrating an example of a sea water desalination pre-treatment system in accordance with one embodiment of the present disclosure;

FIG. 9 is a configuration diagram illustrating an example of an ultra-pure water production subsystem according to one embodiment of the present disclosure; and

FIG. 10 is a configuration diagram of a hollow fiber membrane module system in the ultra-pure water production subsystem according to one embodiment of the present disclosure.

### DETAILED DESCRIPTION

Hereinafter, an embodiment for embodying the present disclosure (hereinafter referred to merely as “the present embodiment”) will be described in detail. The following embodiment is for illustrative purposes only and shall not be construed restrictive in any way. The present disclosure can be practiced as appropriate in various modifications without departing from the scope thereof.

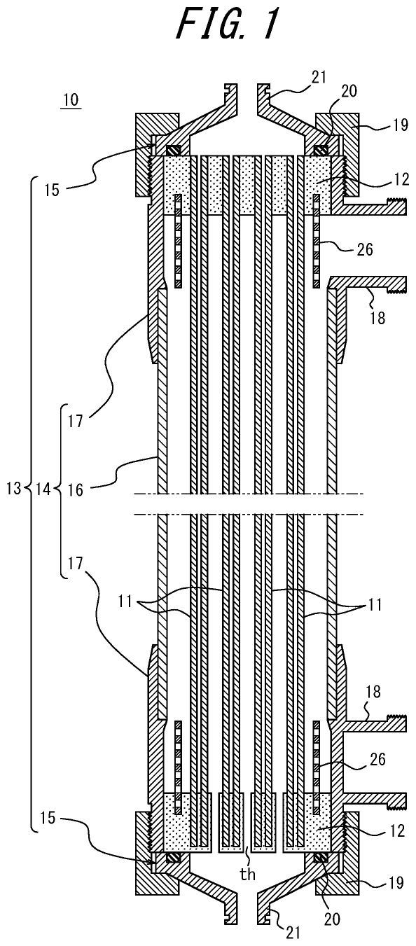

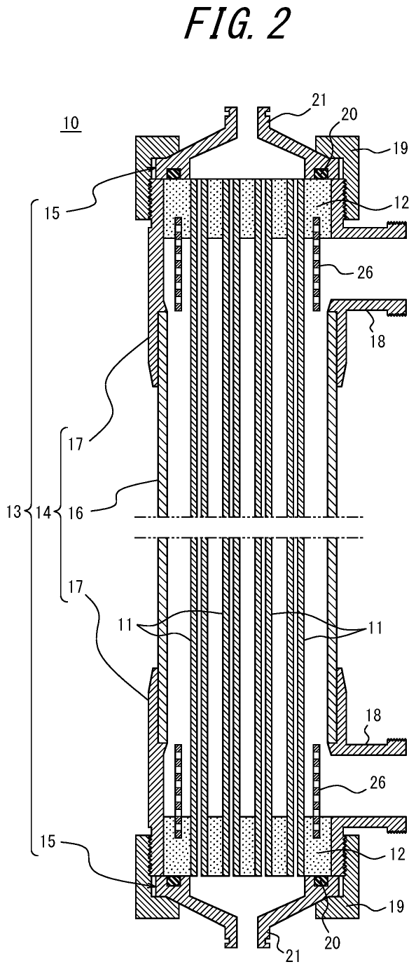

Referring to FIGS. 1 and 2, a hollow fiber membrane module 10 according to the present embodiment may be used for applications of fresh water treatment, food purification, and production of ultra-pure water, for example. The hollow fiber membrane module 10 of the present embodiment comprises hollow fiber membranes 11, a potting material 12, and a module case 13.

The hollow fiber membranes 11 are porous, and fluids passing through the hollow fiber membranes 11 are filtrated. In the present embodiment, the hollow fiber membranes 11 are accommodated in the module case 13 in the form of a hollow fiber membrane bundle composed of the plurality of hollow fiber membranes 11 bundled together.

Examples of the material of the hollow fiber membranes 11 include, but are not particularly limited to, polyvinylidene fluoride, polyolefins such as polyethylene and polypropylene, an ethylene-vinyl alcohol copolymer, polyamide, polyetherimide, polystyrene, polyvinyl alcohol, polyphenylene ether, polyphenylene sulfide, polysulfone, polyethersulfone, acrylonitrile, and cellulose acetate. Of these, from the viewpoint of imparting a strength, preferred are crystalline thermoplastic resins such as crystalline polyethylene, polypropylene, ethylene-vinyl alcohol copolymer, polyvinyl alcohol, and polyvinylidene fluoride. More preferred are polyolefins, polyvinylidene fluoride, and the like which are hydrophobic and thus have high water resistance and are expected to have durability for filtration of typical aqueous liquids. Most preferable is polyvinylidene fluoride which has excellent chemical durability such as chemical resistance. Examples of polyvinylidene fluoride include vinylidene fluoride homopolymers and vinylidene fluoride copolymers that have a molar ration of vinylidene fluoride of 50% by mol or more. Examples of vinylidene fluoride copolymers include copolymers of vinylidene fluoride and one or more monomers selected from tetrafluoroethylene, hexafluoropropylene, trifluorochloroethylene, and ethylene. Vinylidene fluoride homopolymers are most preferred as polyvinylidene fluoride.

The dimension of the hollow fiber membranes 11 is not particularly limited, but hollow fiber membranes having an inner diameter of 0.4 to 3 mm, an outer diameter of 0.8 to 6 mm, a thickness of 0.2 to 1.5 mm, a blocking pore size of the hollow fiber membranes 11 of 0.02 to 1 μm, and a pressure resistance in terms of the transmembrane pressure of 0.1 to 1.0 MPa are preferably used.

The potting material 12 secures at least a part of the hollow fiber membranes 11 to the module case 13. In the present embodiment, the potting material 12 is united with the respective ends of the hollow fiber membranes 11, and is secured to a housing main body 14 (described below) of the module case 13. In the present embodiment, the potting material 12 is formed by filling the potting material 12 between the respective outer circumferential surfaces of the hollow fiber membranes 11 and the inner circumferential surface of the housing main body 14, and curing the filled potting material 12.

The raw material of the potting material 12 is not particularly limited, but dual-liquid mixed curable resins may be used, for example, and a urethane resin, an epoxy resin, and a silicone resin are preferably used. The potting material 12 is desirably selected appropriately, considering the viscosity, the pot life, the hardness and mechanical strength of a cured product, and physical and chemical stabilities when being exposed to a raw liquid, adhesion with the hollow fiber membranes 11, and adhesion with the module case 13. For example, from the viewpoints of reducing manufacturing time and increasing the productivity, a urethane resin with a shorter work life is preferably used. In applications where a higher mechanical strength is required, an epoxy resin having a high mechanical durability is preferably used. Two or more such resins may be used as the potting material 12.

The module case 13 has the hollow fiber membranes 11 accommodated therein. Although the dimension of the module case 13 is not specifically limited, the module case 13 preferably has a full length of 700 to 2500 mm and an outer diameter of 50 to 250 mm. The wall thickness of the module case is desirably 2 to 20 mm, more desirably 4 to 18 mm. The module case 13 has a housing main body 14 and two caps 15.

In the present embodiment, the housing main body 14 is a cylindrical body having the shape of cylinder as a whole, and accommodates the hollow fiber membranes 11 inside the cylindrical body. The housing main body 14 comprises a columnar part 16 and two headers 17, which are separate members in the present embodiment. Alternatively, the columnar part 16 and the headers 17 may be formed as an inseparable one-piece member.

In the present embodiment, the columnar part 16 is cylindrical. The headers 17 are engaged with the respective ends of the columnar part 16. In the present embodiment, the columnar part 16 is bonded to the two headers 17, thereby forming the integral housing main body 14.

In the present embodiment, each header 17 has a cylindrical part. Each header 17 is engaged with the columnar part 16 such that the interior of the cylindrical part of the header 17 is in communication with the interior of the columnar part 16 and the axes of the header 17 and the columnar part 16 coincide with each other. The outer surface of a part of the header 17 engaged with the columnar part 16 may be tapered so as to reduce the step with the outer surface of the columnar part 16, to thereby facilitate covering with a fiber reinforced resin. Alternatively, a circumferential projection or recess may be provided to a part of the outer surface of the header 17 for improving adhesion with a glass cloth or glass roving. Such a structure can more effectively reduce a longitudinal expansion of the hollow fiber membrane module 10 caused by the internal pressure.

In the present embodiment, each header 17 has a nozzle 18. The nozzle 18 is provided on the side of the cylindrical part of the header 17 so as to protrude perpendicularly to the axial direction of the cylindrical part. The nozzle 18 is provided at the position closer to the columnar part 16 in the axial direction of the header 17, relative to the of the corresponding potting material 12.

A nozzle 18 that is open (the upper nozzle 18 in the example in FIG. 1 and both the upper and lower nozzles 18 in the example in FIG. 2) functions as a port to permit passage of a fluid entering to and exiting from the header 17. Thus, the nozzle 18 may permit inflows of a fluid into the internal spaces defined by the inner circumferential surface of the housing main body 14, the outer circumferential surface of each of the hollow fiber membranes 11, and the exposed surface of the potting material 12 from outside, and as well as permitting outflows of the fluid from the internal spaces.

In the present embodiment, each cap 15 has a cylindrical or tapered shape having one open end. The open ends of the caps 15 engage with the housing main body 14 at the respective axial ends of the housing main body 14. In the present embodiment, each cap 15 is secured to the housing main body 14 by nuts 19. An O-ring 20 is provided between each cap 15 and at least one of the potting member 12 and the housing main body 14, such that the internal space defined by the cap 15 and the housing main body 14 is sealed fluid-tightly.

At the closed end or the smaller-diameter end of the taper of each cap 15, a tubular tract 21 is provided. Each tubular tract 21 protrudes so as to extend in parallel to the axial direction of the housing main body 14. Each tubular tract 21 functions as a port to permit passage of a fluid entering to and exiting from the cap 15. Thus, the tubular tract 21 may permit inflows of a fluid into the internal space defined by the cap 15 and the potting member 12 from outside, and as well as permitting outflows of the fluid from the internal space.

In addition, in the example in FIG. 1, the openings at one ends of hollow fiber membranes 11 are exposed to the space defined by the potting material 12 and the cap 15 (on the top of FIG. 1), and the other ends are embedded in the potting material 12 and are closed (on the bottom of FIG. 1). The potting material 12 in which the hollow fiber membranes 11 are embedded is provided with through-holes th extending in the axial direction. The nozzle 18 on the side where the hollow fiber membranes 11 are embedded is closed.

In the hollow fiber membrane module 10 having such a configuration, for example, a raw liquid is introduced from the tubular tract 21 through the through-holes th to the hollow fiber membrane module 10 (on the bottom of FIG. 1) on the side where the hollow fiber membranes 11 are embedded, enters the internal spaces defined by the inner circumferential surface of the housing main body 14, the outer circumferential surfaces of the hollow fiber membranes 11, and the exposed surfaces of the two pieces of potting material 12. While the raw liquid entering the internal spaces passes through the hollow space in the housing main body 14 toward the open nozzle 18 (on the top of FIG. 1), a part of the raw liquid is filtrated through the hollow fiber membranes 11. The filtered liquid (i.e., filtrate) passes through the hollow spaces in the hollow fiber membranes 11 and is discharged from the tubular tract 21 (on the top of FIG. 1) where the openings of the hollow fiber membrane module 10 are exposed. The raw liquid reaching the open nozzle 18 is discharged as a concentrate.

Alternatively, as illustrated in FIG. 2, the hollow fiber membrane module 10 may have a configuration where the openings at the two ends in the longitudinal direction of each hollow fiber membrane 11 are exposed to respective spaces defined by the potting material 12 and the caps 15, no through-hole is defined in either piece of the potting material 12, and both of the nozzles 18 are open.

The hollow fiber membrane module 10 may have a cylindrical flow guide cylinder 26 in each of the headers 17. Each flow guide cylinder 26 is disposed such that the axis thereof coincides with the axis of the header 17. One end of each flow guide cylinder 26 is embedded in the corresponding potting material 12 and the other end terminates at the location closer to the longitudinal center of the columnar part 16 relative to the nozzle 18.

In the hollow fiber membrane module 10 having such a configuration, for example, while a raw liquid that is introduced into the hollow fiber membrane module 10 from one tubular tract 21 passes through the hollow spaces in the hollow fiber membranes 11 toward the other tubular tract 21, a part of the raw liquid is filtrated through the hollow fiber membranes 11. The filtered liquid (i.e., filtrate) enters the internal spaces defined by the inner circumferential surface of the housing main body 14, the outer circumferential surfaces of the hollow fiber membranes, and the exposed surfaces of the two pieces of potting material 12. The filtrate flowing into the internal spaces is discharged from the respective nozzles 18. The raw liquid reaching the opposite tubular tract 21 through the hollow spaces of the hollow fiber membranes is discharged from the opposite tubular tract 21 as a concentrate. Alternatively, the raw liquid may be introduced from one nozzle 18 of the hollow fiber membrane module 10, and the filtrate may be discharged from the tubular tract 21 and the concentrate may be discharged from the other nozzle 18.

At least a part of the module case 13 contains glass fibers. In the present embodiment, the housing main body 14 in the module case 13 contains glass fibers. More specifically, in the present embodiment, at least one of the columnar part 16 and the headers 17, which are cylindrical in the housing main body 14, contains glass fibers. Further specifically, in the present embodiment, the columnar part 16 and the headers 17 contain glass fibers. Suitable glass fibers may be selected from well-known glass fibers in various types having different chemical compositions, such as E-glass, C-glass, S-glass, and D-glass fibers. The headers 17 may be molded from a composite resin material containing a resin and glass short fibers.

The module case 13 includes a plastic part composed of a thermoplastic material and a glass fiber reinforced resin part containing glass fibers. The plastic part can be produce by injection molding or extrusion molding. Parts for the plastic part are molded, which may be later bonded together by heat-welding, solvent bonding, and an adhesive; or the plastic part may be molded into one piece. Examples of the material of the plastic part include polyethylene, polypropylene, polysulfone, polyethersulfone, polyvinylidene fluoride, an ABS resin, a vinyl chloride resin, and modified polyphenylene ether. Although stainless steel can also be used as the material of the module case, a module case made of a plastic is preferable in applications where the module case is brought into contact with sea water for a long time. Similarly, in applications of production of ultra-pure water, a module case made of a plastic is preferable because elution of trace amounts of metal ions is undesirable. The glass fiber reinforced resin part is provided at a glass fiber containing part of the module case 13. The glass fiber reinforced resin part contains a curable resin together with glass fibers. The curable resin may be a thermosetting resin or a photo curable resin, for example. In the present embodiment, the curable resin is a thermosetting resin.

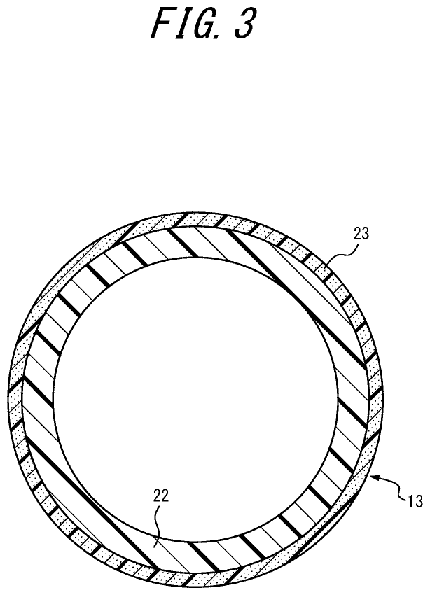

Referring to FIG. 3, the plastic part 22 and the glass fiber reinforced resin part 23 are laminated one another in the wall thickness direction of the module case 13. Specifically, in the present embodiment, a layer of a plastic part 22 is provided inside, and a layer of a glass fiber reinforced resin part 23 is provided on the outer surface side, in the wall thickness direction of the module case 13.

Desirably, the ratio of the thickness of the coating layer of the glass fiber reinforced resin part 23 to the wall thickness of the module case 13 is 5% or more and 50% or less, in at least a part of the glass fiber containing part of the module case 13. In other words, the value of (the layer thickness (in mm) of the coating layer of the glass fiber reinforced resin part 23/the wall thickness (in mm) of the module case 13)×100 is desirably 5% or more and 50% or less. If the ratio is lower than 5%, the effect of the pressure-resistant reinforcement may not be sufficient. On the other hand, if the ratio is higher than 50%, a sufficient effect of pressure resistance may be achieved but other shortcomings may be experienced. For example, excessive curing heat may be generated during molding of the glass fiber reinforced resin part 23, which may cause the plastic part 22 to expand, resulting in problems such as a change in the full length of the module case 13 after curing.

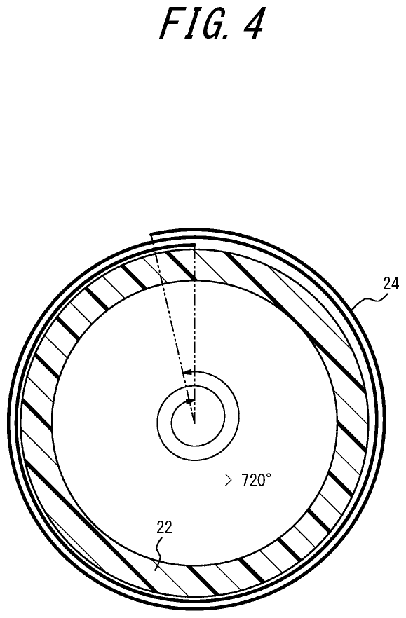

In the present embodiment, the glass fibers composing the glass fiber reinforced resin part 23 are glass long fibers having a length of 3 cm or longer. Referring to FIG. 4, the glass fibers 24 is desirably continuous at least 720° or more about the tubular axis of the plastic part 22, surrounding the outer circumference of the plastic part 22. The continuous winding of the glass fibers 24 around the plastic part 22 uniformly enhances the pressure resistance because no local abnormality occurs when an internal pressure is applied radially inside the plastic part 22.

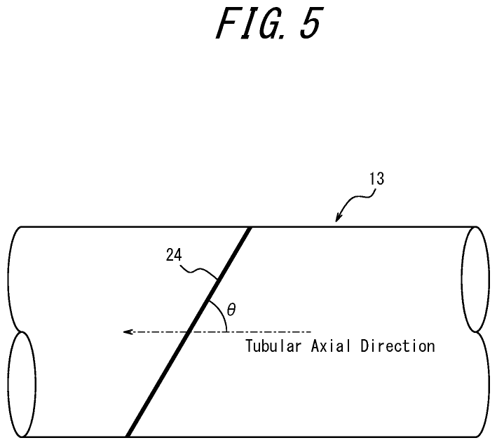

Additionally, referring to FIG. 5, the glass fibers 24 are wound around the module case 13 at an angle θ of 30° to 150° relative to the tubular axial direction of the module case 13. More preferably, the glass fibers 24 are wound around the module case 13 at an angle θ of 45° to 135° relative to the tubular axial direction. Even more preferably, the glass fibers 24 are wound around the module case 13 at an angle θ of 60° to 120° relative to the tubular axial direction. By adjusting the winding angle of the glass fibers 24 relative to the tubular axial direction, the radial expansion and the longitudinal expansion caused by an internal pressure can be reduced in a well-balanced manner.

The surfaces of the glass fibers 24 may be treated with a silane coupling agent for improving adhesion with the thermosetting resin.

In the present disclosure, the glass fibers 24 are continuous glass fibers in the form of a processed fabric body, such as a glass cloth, a roving cloth, and a chopped strand mat, for example, which covers the plastic part 22. A glass cloth is a fabric body of woven strands which are a bundle of twisted glass fibers. A roving cloth is a fabric body of woven strands of untwisted glass fibers. Alternatively, the glass fibers 24 may cover the plastic part 22 in the form of a bundled body, such as a glass roving.

The types of the glass cloth and the roving cloth that can be used may be, but are not particularly limited to, plain weave, twill weave, perforated plain weave, and satin weave. The weight per square meter of the glass cloth, the roving cloth, and the chopped strand mat is desirably 50 g/m² to 600 g/m², more desirably 100 g/m² to 500 g/m², and even more desirably 200 g/m² to 400 g/m². If the weight per square meter is less than 50 g/m², a sufficient strength cannot be provided unless multiple layers of the glass cloth, the roving cloth, or the chopped strand mat are laminated, requiring a cumbersome lamination step. On the other hand, if the weight per square meter is more than 600 g/m², the followability of the glass cloth or the roving cloth to the plastic part may be reduced, resulting in a reduced adhesion. Particularly, in cases where the nozzles 18 are covered with glass cloths or the like, the weight per square meter is desirably 300 g/m² or less because of the complicity of the shape.

Although the type of the glass roving is not specifically limited, the glass roving has a weight per kilometer of desirably 1000 g/km to 5000 g/km, more desirably 1500 g/km to 4500 g/km, and even more desirably 2000 g/km to 4000 g/km. If the weight per kilometer is smaller than 1000 g/km, long time is required to achieve a required lamination amount. On the other hand, if the weight per kilometer is more than 5000 g/km, glass fibers may not be impregnated with a sufficient amount of a curable resin and thus a desired strength may not be imparted.

The volume content of glass fibers (Vf), which is determined by the equation: 100×the volume of glass fiber/(the volume of the glass fiber+the volume of the thermosetting resin) in the glass fiber reinforced resin part 23 is desirably 5 to 70%. If the volume content of glass fibers is lower than 5%, the reinforcing effect may be insufficient. On the other hand, if the volume content of glass fibers is more than 70%, voids are more likely to be created in the glass fiber reinforced resin part 23, which impairs the physical properties of the glass fiber reinforced resin part 23. In addition, the surface of glass fiber reinforced resin part 23 may not be completely covered with the thermosetting resin, and a part of the glass fibers 24 may be exposed. In this case, glass fibers easily break when the glass fibers 24 are rubbed, which makes the glass fibers 24 to be readily fuzzed and may impair the physical properties of the glass fiber reinforced resin part 23. The volume content of glass fibers in the glass fiber reinforced resin part 23 desirably ranges from 20% to 60%.

The width of the fabric body 25 of the glass fibers 24 is desirably 30 mm or more and 140 mm or less. If the width is less than 30 mm, long time is required for a single covering. On the other hand, if the width is more than 140 mm, the fabric body of the glass fibers 24 is prone to twist, which may result in creasing of the fabric body.

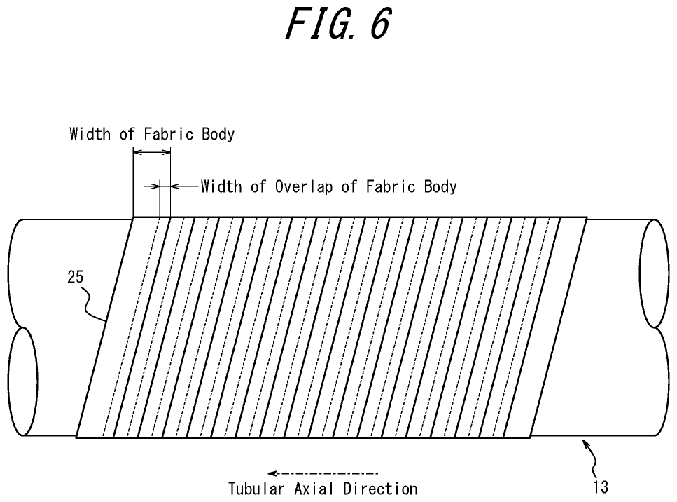

Referring to FIG. 6, the fabric body 25 of the glass fibers 24 is spirally wound around the cylindrical part of the module case 13. Each turn of the fabric body 25 of the glass fibers 24 overlaps the adjacent turn of the fabric body 25, and the overlapping ratio in the tubular axial direction is desirably 3% or more and 70% or less, more desirably 10% to 50%, and even more desirably 20% to 40%, on average. As used herein, the term “overlapping ratio of the fabric body 25 of the glass fibers 24” is the ratio of the width of an overlap of the fabric body 25 to the width of the fabric body 25, in the tubular axial direction. If the overlapping ratio is less than 3%, the fabric body 25 may not be overlapped in a part of the module case 13. On the other hand, if the overlapping ratio is more than 70%, long time is required for the winding step, which is inefficient.

In the present embodiment, a plurality of fabric bodies 25 of glass fibers 24 in different types may be laminated. For example, a plastic part 22 of the module case 13 may be covered with a glass cloth, and the outer circumference covered with the glass cloth may be covered with at least one of a roving cloth and a chopped strand mat. Alternatively, the plastic part 22 may be covered with a roving cloth, and the outer circumference covered with the roving cloth may be covered with at least one of a glass cloth and a chopped strand mat. Further alternatively, the plastic part 22 may be covered with a chopped strand mat, and the outer circumference covered with the chopped strand mat may be covered with at least one of a glass cloth and a roving cloth.

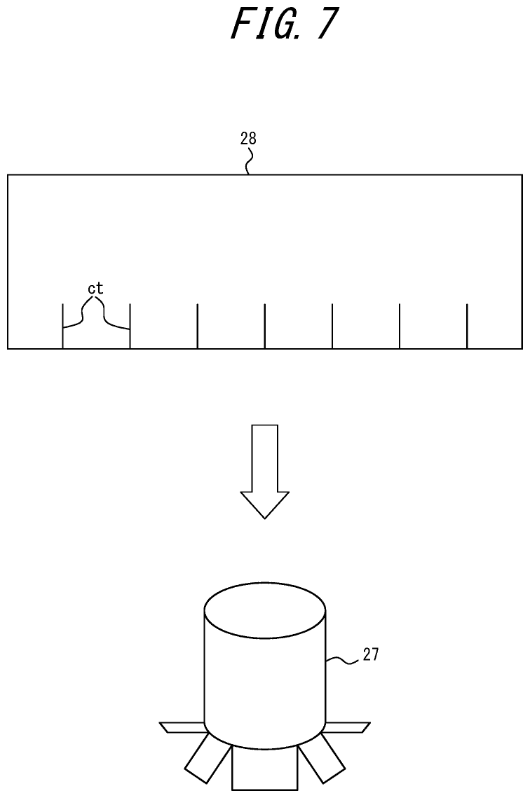

In the hollow fiber membrane module 10 as in the present embodiment, the covering of the glass fiber reinforced resin part 23 may be provided by covering the three types of parts, namely, the columnar part 16, the headers 17, and the nozzles 18, individually with separate glass cloths or the like. In this case, a glass cloth covering the columnar part 16 desirably overlaps glass cloths covering the headers 17 at the boundaries of the columnar part 16 and the headers 17. The width of the overlap is desirably 50 mm or more, although the desired overlapping width varies depending on the structure of the housing. Similarly, a glass cloth covering each header 17 desirably overlap a glass cloth covering the corresponding nozzle 18 at the boundary of the header 17 and the nozzle 18. Referring to FIG. 7, a glass cloth 27 for a nozzle 18 may be cut into a rectangular shape having a long side length sufficient to wrap around the circumference of the nozzle 18 by 360° or more and a short side length sufficient to cover the entire length of the nozzle 18 and the main body of the header 17. Desirably, one of the long sides is provided with slits at appropriate intervals at the bottom so as to increase the followability with the main body of the header 17 and the glass cloth to be overlapped. Stresses tend to concentrate on the base of the nozzle 17, and covering the base with glass fibers can impart a reinforcing effect against the stresses.

Thermosetting resins such as an epoxy resin and an unsaturated polyester resin can be used as the thermosetting resin for the glass fiber reinforced resin part 23, of which an epoxy resin is more preferably used. The epoxy resin may contain, as the main component, bisphenol A, bisphenol F, trimethylol propane polyglycidyl ether, neopentyl glycol diglycidyl ether, 1,4-butanediol diglycidyl ether, 1,6-hexanediol diglycidyl ether, etc., which may be used alone or in combination as appropriate. The curing agent used may be an amine curing agent or an acid anhydride, etc. and an amine curing agent is preferably used for curing the resin at normal temperature. Desirably, the viscosity at the initial stage of mixing of the main component and the curing agent is 500 mPa·s or more and 5000 mPa·s or less. If the viscosity is more than 5000 mPa·s, the epoxy resin becomes less likely to be impregnated into glass fibers, causing air bubbles to remain in the glass fiber reinforced resin part 23. On the other hand, if the viscosity is 500 mPa·s or less, the impregnated epoxy resin may drip from the glass fibers 24, making the epoxy resin difficult to cure in the desired shape.

Next, a method of manufacturing the above-mentioned hollow fiber membrane module 10 will be described. The manufacturing process of the above-mentioned hollow fiber membrane module 10 will be described with reference to an example where a urethane resin is used as the potting material 12. It is to be noted, however, that the resin is not limited to urethane resins, and the hollow fiber membrane module 10 can be fabricated from any other resin in a similar manufacturing process. In the present embodiment, an epoxy resin is used as the potting material 12 for improving the mechanical strength. Alternatively, a urethane resin may be used as the potting material 12 in the present embodiment for reducing the manufacturing time and increasing the productivity.

The hollow fiber membranes 11 are bundled into a hollow fiber membrane bundle having a cylindrical shape so as to be accommodated in the module case 13, to thereby maximize the membrane area, i.e., filtration area, per membrane module. The hollow fiber membrane bundle may be covered with a protective net. The material of the net is not particularly limited, but preferred are polyethylene, polypropylene, polyvinyl alcohol, and an ethylene-vinyl acetate copolymer. Packing the hollow fiber membranes into the module case 13 too tightly may block flows of a raw liquid or a filtrate or may reduce the efficiency of washing in a backwash step during an operation. Depending on the operation, the sum of the cross-sectional areas of the hollow fiber membranes 11 accommodated in the module case 13 desirably accounts for 40 to 70% of the area of the inner diameter of the module case 13. The ends of the hollow fiber membrane bundle are desirably sealed for preventing occlusion with a potting agent in the following potting step. For the sealing, an epoxy resin, a urethane resin, a silicone resin, or the like is used.

After placing the sealed hollow fiber membrane bundle into a plastic part 22 that has been molded into a desired shape, a potting step is carried out in which a potting agent is used to bond the fiber membrane bundle to the ends of the plastic part 22. The adhesion may be achieved by a centrifugal adhesion in which the center of the plastic part 22 is rotated to thereby introduce the potting material 12 by means of the centrifugal force generated by the rotation, or a static adhesion in which the plastic part 22 is placed so as to stand vertically to thereby introduce the potting material 12 by means of the difference of the head. An appropriate adhesion method may be selected, depending on the full length of the hollow fiber membrane module 10, the diameter of the module case 13, and the initial viscosity and the pot life of the potting agent used. After the potting material 12 cures, it may be left to stand at higher temperatures. After the potting material 12 cures completely, the sealed ends of the hollow fiber membranes 11 are removed to open the ends.

Although the present embodiment has been described in which the covering step of the glass fiber reinforced resin part b 23 is carried out after the step of potting the hollow fiber membrane bundle into the plastic part 22, the covering step may be carried out prior to the bonding step.

The outer surface of the plastic part 22 may be subjected to a surface treatment for improving adhesion between the plastic part 22 and glass fiber reinforced resin part 23. Examples of the surface treatment include, but are not specifically limited to, a chemical treatment, a plasma treatment, and roughening. Roughening can be carried out by a sand paper or sandblasting, and removal of dusts after the roughening is crucial to maintain a favorable adhesion. The roughening is carried out until the surface roughness (Ra) represented by an arithmetic average roughness of preferably 1 μm or more, more preferably 5 μm or more, is obtained. The surface roughness is determined in accordance with JIS B 0601:1994.

For achieving a tighter bonding of the plastic part 22 and the glass fiber reinforced resin part 23, a high strength of the adhesion between the outer surface of the plastic part 22 and the glass fiber reinforced resin part 23 is suitably maintained. For example, the tensile shear strength is desirably 3 MPa or more. The tensile shear strength is more desirably 4.5 MPa or more.

After the above-mentioned potting step, a covering step for the glass fiber reinforced resin part 23 is carried out. In the covering step, for continuous covering with a fabric body 25 of the glass fibers 24, such as a glass cloth and a roving cloth, a suitable pressure resistance particularly against a radial expansion is provided by winding the fabric body 25 of the glass fibers 24 around the plastic part 22 such that each turn of the fabric body 25 overlaps a part of the adjacent turn of the fabric body 25. A hoop winding is a spiral winding approximately perpendicular to the axial direction, and includes a spiral winding with a slight tilt relative to the axial direction. Alternatively, a spiral winding having a tilt relative to the axial direction, known as helical winding, may also be used to reduce a longitudinal expansion. The fabric body 25 is desirably wound such that there is no gap between the fabric body 25 and the plastic part 22. The ratio of an overlap of each turn of the fabric body 25 of the glass fibers 24 as mentioned above is desirably 3% to 70%, more desirably 10% to 50%, and even more desirably 20% to 40%, on average.

As mentioned above, the width of the glass cloth is appropriately 30 mm to 140 mm, although the appropriate width varies depending on the diameter of the module case 13. Winding may be carried out with a dedicated apparatus or done manually. During winding, the plastic part 22 may be rotated about the tubular axis.

A filament winding apparatus may be used as a dedicated apparatus. An exemplary filament winding apparatus may be configured and operated as follows. First, a bobbin, i.e., a bundled roving is attached to a yarn feeder known as a creel stand, and a glass roving is fed while the tension is controlled. Subsequently, the glass roving is passed through an impregnation device known as resin bath, so that the glass roving is impregnated with a thermosetting resin. The amount of the resin impregnated is regulated as appropriate, based on a desired fiber volume content (Vf), which is the ratio of glass fibers in a glass fiber reinforced resin. In addition, the temperature of the resin bath may also be regulated as appropriate. On the other hand, a hollow fiber membrane module 10 or a housing main body 14 is secured to the main body of the filament winding apparatus. The hollow fiber membrane module 10 may be secured by holding the outer surfaces of the ends of the hollow fiber membrane module 10. The housing main body 14 before accommodating the hollow fiber membranes 11 may be secured by similarly holding the outer surfaces or by holding the inner surfaces, of the ends of the housing main body 14, and how to secure the housing main body 14 may be appropriately selected considering handleability during processing steps, including a subsequent curing step. After an end of the glass roving is secured to a part of the housing main body 14, the housing main body 14 is rotated such that the roving is wound around the housing main body 14. The tension of the glass fibers being wound is appropriately regulated to 0.1 N to 30 N per glass roving reeled out from each bobbin. If the tension is smaller than 0.1 N, the adhesion to the surface of the housing main body 14 or the effect of the tension to remove an excess amount of the impregnated resin may be impaired. On the other hand, if the tension is greater than 30 N, an extra load may be exerted on the a workpiece, i.e., the housing, which may result in a residual stress. The rotation speed of the housing main body 14 can be appropriately regulated in a range of 10 m/min to 200 m/min, preferably in a range of 20 m/min to 160 m/min, more preferably in a range of 40 m/min to 120 m/min. A heater may be provided above the housing main body 14 to facilitate curing during winding. When the resin to be impregnated is a light curable resin, a device for generating ultraviolet light may be provided.

Depending on the designed pressure resistance requirement, the aforementioned hoop winding or helical winding may be repeated.

Further, if required, the outer circumference provided with hoop winding may be covered with a roving cloth having an area sufficient to cover the glass cloth. In this case, one end of the roving cloth may overlap the other end by 1 cm or more, desirably 3 cm or more, and even more desirably 5 cm or more. In addition, it is important to cut the roving cloth beforehand to a length appropriate to the nozzle 18, etc. of the module case 13, and covering is done such that creasing is minimized. Air bubbles tend to remain in parts having complex shapes, such as the nozzles 18, after an impregnation with a thermosetting resin, as will be described below. Thus, removal of air bubbles with a tool, such as a roller, can assure a sufficient pressure resistance.

If required, the outer circumference of the roving cloth may be covered with a chopped strand.

The above-mentioned fabric body 25 of the glass fibers 24, such as a roving cloth, a glass clothes, or a chopped strand mat, is impregnated with a thermosetting resin. The fabric body 25 of the glass fibers 24 may be impregnated with the thermosetting resin before or after the fabric body 25 is wound around the plastic part 22. Alternatively, the thermosetting resin may be applied to the outer surface of the plastic part 22 before the winding. Depending on the materials used in the hollow fiber membranes 11 and the module case 13, desirably, the thermosetting resin impregnated in the fabric body 25 of the glass fibers 24 is cured at room temperature, and then left to stand at a temperature between 50° C. and 80° C. By making the thermosetting resin to be completely cured, weather resistance, chemical resistance, and durability are assured. When being stood at a temperature exceeding 80° C., suitable strengths are achieved for the glass fiber reinforced resin part 23 per se and for the shear strength of the outer surface of the plastic part 22 and glass fiber reinforced resin part 23. Depending on the types of the other materials employed for the plastic part 22 or the hollow fiber membrane module 10, however, the standing temperature may exceed the heat resistance temperature of the material. If the hollow fiber membranes 11 are dried at such high temperatures for a long time, water permeability may not be maintained due to evaporation of moisture from the pores of the hollow fiber membranes 11.

After being stood, the surface layer of the glass fiber reinforced resin part 23 may be sanded as needed. In some applications, the surface layer of the glass fiber reinforced resin part 23 may be coated. The thickness of the coating may be 30 μm at maximum. If the coating is thicker than 30 μm, the organic solvent in the paint may not be evaporated and remain as air bubbles. A covering with a heat-shrinkable films may also be provided. The covering with the heat-shrinkable film may be provided after being stood or after winding and before being stood.

According to the hollow fiber membrane module 10 configured as described above, for example, by introducing raw water into the hollow fiber membrane module 10 via one nozzle 18, the filtrate water filtrated through the hollow fiber membranes 11 is discharged from the hollow fiber membrane module 10 via at least one of the tubular tracts 21, and concentrated water is discharged from the hollow fiber membrane module 10 via the other nozzle 18.

Or, by introducing a raw liquid into the hollow fiber membrane module 10 via one of the tubular tracts 21, concentrated water is discharged from the hollow fiber membrane module 10 via the other tubular tract 21, and filtrate water filtrated through the hollow fiber membranes 11 is discharged from the hollow fiber membrane module 10 via the two nozzles 18.

In addition, by covering the outer circumference of the plastic part 22 with the glass fiber reinforced resin part 23, it is possible to prevent the raw liquid such as raw water from contacting the glass fiber reinforced resin part 23. Thus, the hollow fiber membrane module 10 may also be applied for applications where contacts between the raw liquid and a resin containing the glass fibers 24 are undesirable.

A filtration system comprising the hollow fiber membrane module 10 according to the present embodiment will be specifically described below.

In the filtration system described below, a filtration is carried out under a pressure inside the hollow fiber membrane module 10 of 0.3 MPa to 1.2 MPa. Unless otherwise stated, the expression that “a filtration is carried out at 0.3 MPa to 1.2 MPa” means that a pressure of 0.3 MPa to 1.2 MPa is applied inside the hollow fiber membrane module 10 during at least one of the filtration and reverse washing steps. The expression that “a pressure is applied inside the hollow fiber membrane module 10” means that the pressure is applied at least inside the housing main body 14.

In the filtration system, the relationship: 0.5<R/L<5 may be satisfied while a pressure of 1.0 MPa is applied inside the module case 13, where R (%) represents the radial expansion ratio at a center portion in the longitudinal direction of the columnar part 16, and L (%) represents a longitudinal expansion ratio of the columnar part 16. If the R/L is smaller than 0.5, the longitudinal expansion ratio L is larger than the radial expansion ratio. In this case, when the longitudinal direction is restrained, a greater load may be generated in the radial direction than as usual. If the R/L is 5 or more, the radial expansion ratio is high. In this case, when a stress with a longitudinal restraint is exerted radially, long-term stress changes may not be tolerated.

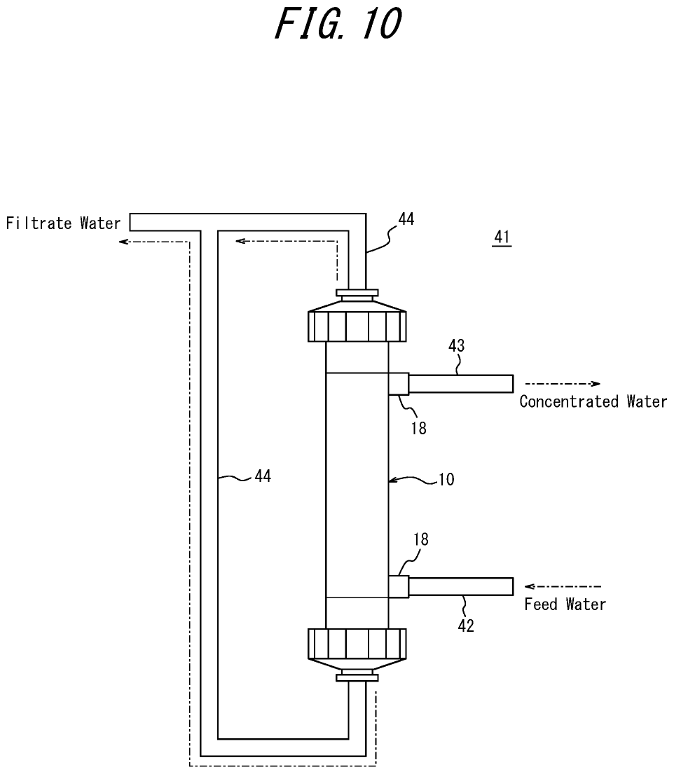

In the filtration system, the relationships: 0<R<0.25 and 0<L<0.06 may be satisfied during an operation to carry out the above-mentioned filtration. If R is 0.25 or greater, the module case 13 may be cracked due to an operation of long-time filtration under high pressures and pressure fluctuations caused by switching between operation steps. On the other hand, if the L is 0.06 or more, an operation of long-time filtration under high pressures and pressure fluctuations caused by switching between operation steps may result in a crack in a feed pipe 42, a discharge pipe 43, and a filtrate pipe 44 connected to the hollow fiber membrane module 10 due to an excessive load thereon, as illustrated in detail in FIG. 10, caused by the pressure fluctuations caused by switching between operation steps. Desirably, the load during an operation to carry out the filtration is 1.2 MPa at maximum inside the module case 13 at room temperature, 0.9 MPa at maximum inside the module case 13 at a liquid temperature of 40° C., and 0.8 MPa at maximum inside the module case 13 at a liquid temperature of 80° C.

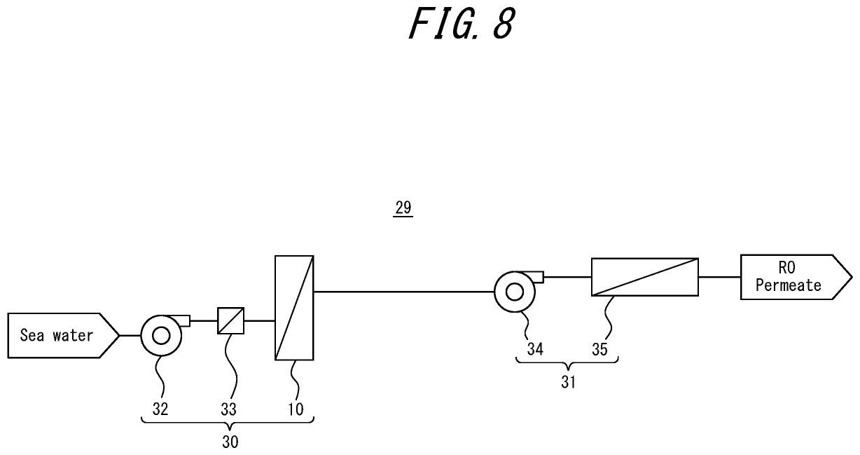

Referring to FIG. 8, a sea water desalination system 29, which embodies the filtration system according to the present embodiment as a system for desalinating sea water or a system for producing fresh water, comprises a filtration system 30 and a desalting system 31.

The filtration system 30 comprises a filtration feed pump 32, a strainer 33, and a pressure-resistant hollow fiber membrane module 10. The filtration feed pump 32 draws sea water and feeds it to the hollow fiber membrane module 10. The strainer 33 removes foreign matters having relatively large sizes from the sea water. The hollow fiber membrane module 10 filtrates the sea water. i.e., raw water. The drawn water may be subjected to pressure flotation separation before it is fed to the hollow fiber membrane module 10.

The desalting system 31 comprises a desalting feed pump 34 and a reverse osmosis membrane module 35. The desalting feed pump 34 pressurizes the filtrate from the hollow fiber membrane module 10 to feed it to the reverse permeation membrane module 35. The reverse osmosis membrane module 35 desalts the filtrate from the hollow fiber membrane module 10. It is to be noted that the desalting system 31 may not be provided with a desalting feed pump 33. In other words, the hollow fiber membrane module 10 may be directly connected to the reverse osmosis membrane module 35.

The hollow fiber membrane module 10 of the present disclosure is pressure resistant. Thus, even when no buffer tank is provided between the hollow fiber membrane module 10 and the reverse osmosis membrane module 35, the desalting step can be carried out continuously without causing any damage to the hollow fiber membrane module 10 or leakage of the filtrate. The absence of a buffer tank reduces the footprint of the sea water desalination system 29 and reduces the costs related to chemical agents used in a buffer tank. Further, in the configuration in which the pipes connected to the top and bottom of the hollow fiber membrane module 10 and the nozzles 18 are made of polyethylene or a polyvinyl chloride resin, the structure is provided such that the longitudinal expansion ratio and the radial expansion ratio of the hollow fiber membrane module 10 can be reduced in a well-balanced manner even when pressures are created by the raw liquid that is fed. Thus, not only the hollow fiber membrane module 10 but also the connected pipes can be maintained to be operable for a long time.

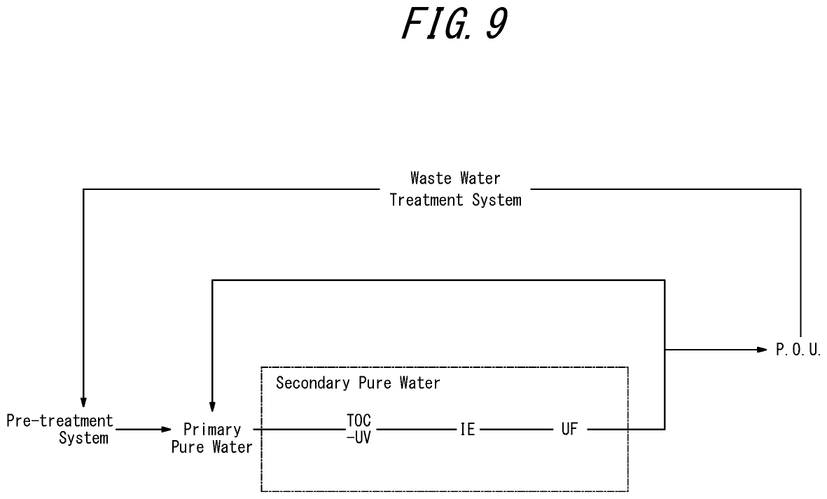

FIG. 9 illustrates an embodiment of an ultra-pure water production system which embodies the filtration system according to the present embodiment as a system for producing ultra-pure water. In the ultra-pure water production system, matters suspended in raw water are removed and residual oxygen is removed (in a pre-treatment system). Then, water, ions, and organic matters are separated from each other by a reverse osmosis membrane (primary pure water). Subsequently, the resultant water is treated by an ion exchange device (IE) for desalting. Although most of the organic matters are removed by the RO membrane, the residual organic matters may be further reduced by providing an ultraviolet radiation device (TOC-UV). Then, the water is filtrated through an ultrafiltration membrane module (UF) as the final filter, to remove fine particles, and a part of the resultant water is supplied to a point of use (P. O. U). A part of water used at the point of use (P. O. U) is treated by a waste water treatment system, and is then supplied to the point of use (P. O. U) again after being subjected to the processes in the ultra-pure water production system. The proportion of water supplied to the point of use (P. O. U) varies depending on the conditions at the point of use (P. O. U), but may account for about 20 to 50% of the amount of the water circulated in the subsystem, or about 70% in a line having an further increased efficiency.

Referring to FIG. 10, a system 41 for producing ultra-pure water by removing fine particles, which embodies the filtration system according to the present embodiment, comprises a pressure-resistant hollow fiber membrane module 10, a feed pipe 42, a discharge pipe 43, and a filtrate pipe 44. The feed pipe 42 is connected to one nozzle 18 of the hollow fiber membrane module 10. The discharge pipe 43 drains concentrated water from the other nozzle 18. The filtrate pipe 44 collects filtrate water from the hollow fiber membrane module 10. Water filtrated through the hollow fiber membrane module 10 contains only one particle with a size of 50 nm or greater per 1 mL, and can be used as ultra-pure water for semiconductor manufacturing, for example.

For example, in the above-mentioned system 41 for producing ultra-pure water, the hollow fiber membrane module 10 may be operated at a maximum pressure on the feed water side of 0.5 MPa or more and 0.8 MPa or less, a maximum pressure on the filtrate water side of 0.3 MPa or less, and a maximum differential pressure across the membranes of 0.3 MPa or less, using the external pressure filtration method, under an operating condition with a fluid temperature at 80° C. at maximum.

Alternatively or additionally, for example, in the above-mentioned ultra-pure water production system 41, the hollow fiber membrane module 10 may be operated at a maximum pressure on the feed water side of 0.5 MPa or more and 0.8 MPa or less, a maximum pressure on the filtrate water side of 0.5 MPa or more and 0.8 MPa or less, and a maximum differential pressure across the membranes of 0.3 MPa or less, using the external pressure filtration method, under an operating condition where raw water at 70° C. or more and 80° C. or less is fed.

Alternatively or additionally, for example, in the above-mentioned ultra-pure water production system 41, the hollow fiber membrane module 10 may be operated at a maximum pressure on the feed water side of 0.8 MPa or more and 1.2 MPa or less, a maximum pressure on the filtrate water side of 0.8 MPa or more and 1.2 MPa or less, and a maximum differential pressure across the membranes of 0.3 MPa or less, using the external pressure filtration method, under an operating condition where raw water at 20° C. or more and 30° C. or less is fed.

The hollow fiber membrane module 10 in the external pressure filtration scheme in the present embodiment is pressure resistant. Thus, even when the pressure on the raw water supply side is 1.2 MPa at maximum at normal temperature to achieve a high water permeability of exceeding 15 m³/h, for example, a filtration operation can be carried out without causing any damage to the case. In addition, the filtration operation can be carried out under a pressure on the raw water supply side of 0.8 MPa at maximum for hot water from 70° C. to 80° C. When water is drawn from the ultra-pure water production subsystem to the point of use, the pressure inside the circulation pipes of the ultra-pure water production subsystem instantaneously drops but returns to a steady pressure afterward. Such repetitive pressure fluctuations may exert loads on the housing main body 14 of the hollow fiber membrane module 10 and the connected pipes. However, in the hollow fiber membrane module 10 of the present embodiment, since the radial expansion ratio and the full length expansion ratio of the hollow fiber membrane module 10 are reduced in a well-balanced manner, a filtration operation can be continued for a long time while minimizing the weight increase due to the pressure resistance reinforcement. The glass fibers 24 included in the glass fiber reinforced resin part 23 are not exposed to the inner surface of the housing main body 14. Thus, elution of ionic silica and silicone components can be minimized while maintaining the pressure resistance. The epoxy resin used in the glass fiber reinforced resin part 23 contains chloride ions at a concentration of hundreds of ppm to thousands of ppm. However, since the epoxy resin in the glass fiber reinforced resin part 23 does not contact a filtrate in the present embodiment, no chloride ions are transferred to the filtrate, ensuring that a high-quality filtrate is supplied to points of use.

### EXAMPLES

Although the present disclosure will be described in more detail with reference to examples, the present disclosure is not limited to the examples.

The procedures for measurements and tests employed in the examples will be described below.

(Thickness of Glass Fiber Reinforced Resin Part)

The thickness of each glass fiber reinforced resin part was measured in the following procedure. A module case provided with a covering was cut to thereby expose the cross-section of a glass fiber reinforced resin part, and the thicknesses at three points in the cross-section were measured and averaged.

(Inner and Outer Diameters of Hollow Fiber Membranes)

The inner and outer diameters of each hollow fiber membrane were determined as follows. A hollow fiber membrane was sliced with a razor or a similar tool along the direction perpendicular to the longitudinal direction, and the inner and outer lengths along the major and minor axes in the cross-section were measured under a scanning electron microscope. The inner and outer diameters were determined by the following equations (1) and (2), respectively. In the present embodiment, the inner and outer diameters were measured for 20 arbitrarily selected hollow fiber membranes, and the respective arithmetic averages were calculated.

$$\begin{matrix}Inner diameter ( mm ) = \{ inner major length ( mm ) + inner miner length ( mm ) \} / 2 & Eq . 1 \\ Outer diameter ( mm ) = \{ outer major length ( mm ) + outer miner length ( mm ) \} / 2 & Eq . 2\end{matrix}$$

(Thickness of Hollow Fiber Membrane in Thickness Direction)

The thickness of a hollow fiber membrane in the thickness direction was determined as follows. The inner diameter (A) and the outer diameter (B) of a hollow fiber membrane were measured as mentioned above, and the thickness of the hollow fiber membrane in the thickness direction was determined based on the following Eq. 3:

$$Thickness of hollow fiber membrane = ( B - A ) / 2 \qquad Eq . 3$$

In the present embodiment, the inner and outer diameters were measured for the 20 arbitrarily selected hollow fiber membranes, and the thickness was determined by calculating the arithmetic average.

(Glass Transition Temperature)

Glass transition temperatures were measured using a differential scanning calorimeter (DSC) apparatus manufactured by Perkin Elmer Inc. under the product name of DSC8000. Measurements were carried out in accordance with JIS K7121 Test Method for Transition Temperatures. Indium was used as a reference material. Specifically, 5 mg of glass fibers reinforced resin were collected from a finished product of a hollow fiber membrane module as a sample, and were placed in a special sample container. After the sample container was placed in the apparatus and the temperature in the apparatus was kept to 20° C., a test was started. The temperature of the sample was elevated in a range from 0° C. to 200° C. The temperature was elevated at a rate of 10° C./min. The mid-point glass transition temperature (Tg) was calculated from the obtained results, which was used as a glass transition temperature.

(Tensile Shear Strength)

Tensile shear strengths were measured in the following procedure. A sample was cut out from a columnar part of a membrane module that was actually produced. The sample was cut in the longitudinal direction of the columnar part into a stick shape with a length of 180 mm and a width of 10 mm. The layers of the sample were then removed other than a center portion of 12.5 mm×10 mm in the longitudinal direction of the sample such that only the plastic part (polysulfone or ABS, described below) remained on one side and only the glass fiber reinforced resin part remained on the other side. Each shear test was carried out by setting other conditions in accordance with JIS K 7161 Plastics—Determination of tensile properties.

(Instantaneous Destruction Test)

Each instantaneous destruction test was carried out by varying internal pressures applied inside a hollow fiber membrane module, and the pressure when the case was broken was determined as the pressure upon breaking. After the hollow fiber membrane module was filled with water, the two nozzles and one cap were sealed. Air was gradually introduced from the one unsealed cap at 0.2 MPa/sec. Each test was carried out using water at a temperature of 40° C. Each hollow fiber membrane module was tested without the hollow fiber membrane module being restrained in the longitudinal direction.

(Fatigue Destruction Test)

A fatigue destruction test was carried out by repeatedly applying internal pressures up to 0.6 MPa or 1 MPa on a hollow fiber membrane module, and the cycle count at the time when the case was broken was recorded. After the hollow fiber membrane module was filled with water, the two nozzles and one cap were sealed. Air pressure was applied from the one unsealed cap. The frequency for applying pressures was 6 cycles per minute. Each test was carried out using water at a temperature of 40° C. Each hollow fiber membrane module was tested without the hollow fiber membrane module being restrained in the longitudinal direction.

(Measurements of Radial Expansion Ratio and Full Length Expansion Ratio of Housing)

The radial expansion ratio and the full length expansion ratio of a housing were measured in the following procedure. After the hollow fiber membrane module was filled with water, the two nozzles and one cap were sealed. Air pressure was applied from the one unsealed cap. The frequency of the application of the pressure was 6 cycles per minute. Each test was carried out using water at a temperature of 40° C. Variations in the diameter and the full length of the columnar part were measured using a caliper (manufactured by Mitsutoyo Corporation) before and after the application of the pressure.

(Measurement of Lengths of Glass Fibers)

Lengths of glass fibers were determined by tomographically observing a sample in an X-ray computed tomography (CT) apparatus. As the X-ray CT apparatus, a high resolution 3DX microscope nano3DX manufactured by Rigaku Corporation was used. When measurements with the above method was difficult, components other than glass fibers in a glass fiber reinforced resin part were combusted at 400° C. in a heating furnace or any other apparatus, and the lengths of glass fibers were measured using a scale, or under an optical microscope or an electron microscope.

(Measurement of Fiber Volume Content)

A fiber volume content (Vf) was measured in the following procedure. A thermosetting resin was removed from a glass fiber reinforced resin part to determine the masses of glass fibers and the thermosetting resin. The values of the masses were converted into the volumes from the respective densities, and the resultant values of the volumes were substituted into the equation described above. The thermosetting resin can be removed from the glass fiber reinforced resin part by means of combustion (thermal decomposition) as a simple and preferred method. In this method, the glass fiber reinforced resin part was dried thoroughly and was then weighed. The glass fiber reinforced resin part was then placed in an electric furnace etc. at 400° C. to 700° C. for 60 to 240 minutes to combust the thermosetting resin component. The residual reinforcing fibers after the combustion was allowed to cool in a dry atmosphere. The reinforcing fibers were then weighed, and the masses of the components were determined.

### Example 1

In Example 1, an ABS resin (manufactured by Asahi Kasei) was used as the material for a plastic part of a module case. The outer surface of the plastic part was roughened by a sand paper for improving adhesion. The surface roughness (Ra) after the roughening with a #100 sand paper was 6.6 μm. All coverings of the glass fiber reinforced resin parts were carried out by hand lay-up. A bandage-like glass cloth having a width of 100 mm (manufactured by Maeda Glass Co., Ltd. under the product name of ECM13100-A) was continuously wound around the outer circumference of the plastic part of the columnar part such that each turn of the glass cloth overlapped the adjacent turn by 30% on average. In this case, the length of warp yarns, i.e., glass fibers approximately parallel to the tubular axis of the module, was approximately 100 mm and the length of warp yarns, i.e., glass fiber approximately perpendicular to the tubular axis, was approximately 18 m. The glass cloth used was plain weave cloth in which warp and weft yarns, which were orthogonal to each other, interlaced over and under each other in alternating fashion. Thereafter, a sheet-like chopped strand mat (manufactured by Nitto Boseki Co., Ltd. under the product name of MC300-A) was wound such that a single layer of the chopped strand mat was laminated. The average length of the glass fibers composing the chopped strand mat was 5 cm, and the glass fibers were randomly oriented in a sheet and fixed by a binder. An epoxy resin impregnation was carried out after the winding, and air was removed by pressing with a roller. Similarly, a glass cloth and a chopped strand mat were wound around the headers and the nozzles. An epoxy resin used was a blend of JER811 (manufactured by Mitsubishi Chemical Corporation) as the main component, triethylene tetramine (TETA) (manufactured by Tosoh Corporation) as the curing agent, and SR-TMP (manufactured by Sakamoto Yakuhin kogyo Co., Ltd.) as the reactive diluent. The glass cloth and the chopped strand mat were impregnated with the epoxy resin, and the workpiece was left to stand for 8 hours in the environment at 50° C. while being rotated to cure the epoxy resin, to thereby produce a hollow fiber membrane module of Example 1.

The pipe diameters of the center portion of the columnar part were measured with the caliper before and after an internal pressure of 1.0 MPa was applied inside the hollow fiber membrane module in Example 1 in a free state where the hollow fiber membrane module was not restrained. The change in the full length of the hollow fiber membrane module before and after the application of the internal pressure was similarly measured. The radial expansion ratio R of the center portion was 0.21%, the full length expansion ratio L was 0.048%, giving an R/L of 4.38. An instantaneous destruction test was then carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the module case was not broken under the internal pressures up to at least 5 MPa in the hollow fiber membrane module in Example 1. A cycle durability test from 0 to 0.6 MPa was carried out similarly without the hollow fiber membrane module being restrained in the longitudinal direction, and no breaking of the hollow fiber membrane module was confirmed up to 500,000 cycles. After completion of the test, the hollow fiber membrane module was disassembled and no abnormalities were observed. The fiber volume content (Vf) in the glass fiber reinforced resin covering the columnar part was determined to be 40%.

TABLE 1

| | | | | Example | Example | Example | Example | Example | Example | Comp. | Comp. |
|---|---|---|---|---|---|---|---|---|---|---|---|
| | | | | 1 | 2 | 3 | 4 | 5 | 6 | Ex. 1 | Ex. 2 |
| Hollow fiber | Material | | | PVDF | PVDF | PVDF | PVDF | Polysulfone | PVDF | PVDF | Polysulfone |
| membrane | Inner diameter/outer diameter (mm) | | | 0.67/1.22 | 0.67/1.22 | 0.67/1.22 | 0.67/1.22 | 0.6/1.0 | 0.67/1.22 | 0.67/1.22 | 0.6/1.0 |
| Potting material | | | | Urethane | Urethane | Urethane | Urethane | Epoxy | Urethane | Urethane | Epoxy |
| | | | | resin | resin | resin | resin | resin | resin | resin | resin |
| Housing | Plastic part | Columnar part | | ABS | ABS | ABS | ABS | Polysulfone | ABS | ABS | Polysulfone |
| | | Headers and nozzles | | ABS | ABS | ABS | GF-ABS | Polysulfone | ABS | ABS | Polysulfone |
| | Glass fiber | Columnar | Covering method | Hand | Hand | Filament | Filament | Hand | Filament | — | — |
| | reinforced resin | part | | lay-up | lay-up | winding | winding | lay-up | winding | | |
| | part | | Glass roving | — | — | Single | Single | — | Single | — | — |
| | | | Number of glass roving (g/1000 m) | — | — | 2200 | 2200 | — | 2200 | — | — |
| | | | Angle (°) relative to tubular axis at pipe center | — | — | 30 | 30 | — | 30 | — | — |
| | | | Bandage-like glass cloth | Single | Single | — | — | Dual | — | — | — |
| | | | Unit area weight (g/m²) of bandage-like glass cloth | 100 | 100 | — | — | 300 | — | — | — |
| | | | Angle (°) wound continuously relative to tubular axis | 750 | 750 | — | — | 750 | — | — | — |
| | | | Width of bandage-hke cloth (mm) | 100 | 100 | — | — | 50 | — | — | — |
| | | | Width of overlap of bandage-like cloth (mm) | 30 | 70 | — | — | 15 | — | — | — |
| | | | Percentage of overlap of bandage-like cloth | 30 | 70 | — | — | 30 | — | — | — |
| | | | Sheet roving cloth | — | — | — | — | Dual | — | — | — |
| | | | Unit area weight (g/m²) of sheet roving cloth | — | — | — | — | 350 | — | — | — |
| | | | Chopped strand mat | Single | Single | — | — | Dual | — | — | — |
| | | | Unit area weight (g/m²) of chopped strand mat | 300 | 300 | — | — | 380 | — | — | — |
| | | | Thickness of plastic part (mm) | 5.5 | 5.5 | 5.5 | 5.5 | 6.5 | 5.5 | 5.5 | 6.5 |
| | | | Thickness of glass filer reinforced resin part (mm) | 1.68 | 2.57 | 0.9 | 0.9 | 6.4 | 0.9 | 0 | 0 |
| | | | Percentage (%) of wall thickness | 23.4 | 31.8 | 14.1 | 14.1 | 49.6 | 14.1 | 0.0 | 0.0 |
| | | | Width of overlap of glass filer to headers (mm) | 50.0 | 50.0 | 40.0 | 40.0 | 50.0 | — | — | — |
| | | Headers | Covering method | Hand | Hand | Hand | — | Hand | — | — | — |
| | | | | lay-up | lay-up | lay-up | | lay-up | | | |
| | | | Sheet roving cloth | Single | Single | Single | — | Dual | — | — | — |
| | | | Unit area weight (g/m²) of sheet roving cloth | 150 | 150 | 150 | — | 300 | — | — | — |
| | | | Chopped strand mat | Single | Single | Single | — | Dual | — | — | — |
| | | | Unit area weight (g/m²) of chopped strand mat | 300 | 300 | 300 | — | 300 | — | — | — |
| | | | Angle (°) of glass filer in mat relative to tubular axis direction | 0-90 | 0-90 | 0-90 | — | 0-90 | — | — | — |
| | | | Thickness of plastic part (mm) | 10 | 10 | 10 | 10 | 10 | 10 | 10 | 10 |
| | | | Thickness of glass filer reinforced resin part (mm) | 2.1 | 2.1 | 2.1 | 0 | 6 | 0 | 0 | 0 |
| | | | Percentage (%) of wall thickness | 17.4 | 17.4 | 17.4 | 0.0 | 37.5 | 0.0 | 0.0 | 0.0 |
| | | Nozzles | Covering method | Hand | Hand | Hand | — | Hand | — | — | — |
| | | | | lay-up | lay-up | lay-up | | lay-up | | | |
| | | | Sheet roving cloth | Single | Single | Single | — | Dual | — | — | — |
| | | | Unit area weight (g/m²) of sheet roving cloth | 150 | 150 | 150 | — | 300 | — | — | — |
| | | | Chopped strand mat | Single | Single | Single | — | Dual | — | — | — |
| | | | Unit area weight (g/m²) of chopped strand mat | 300 | 300 | 300 | — | 300 | — | — | — |
| | | | Angle (°) of glass filer in mat relative to tubular axis direction | 0-90 | 0-90 | 0-90 | — | 0-90 | — | — | — |
| | | | Thickness of plastic part (mm) | 6 | 6 | 6 | 6 | 10 | 6 | 6 | 10 |
| | | | Thickness of glass filer reinforced resin part (mm) | 2.1 | 2.1 | 2.1 | 0 | 6 | 0 | 0 | 0 |
| | | | Width of overlap of header on glass filer of nozzle part (mm) | 25 | 25 | 25 | 0 | 25 | 0 | 0 | 0 |
| | | | Percentage (%) of wall thickness | 26 | 26 | 26 | 0 | 38 | 0 | 0 | 0 |
| | | Impregnated | Main component | JER811 | JER811 | XNR6805 | XNR6805 | JER811 | XNR6805 | — | — |
| | | resin | Curing agent | TETA | TETA | XNH6805 | XNH6805 | TETA | XNH6805 | — | — |
| | | | Reactive diluent | SR-TMP | SR-TMP | XNA6805 | XNA6805 | SR-TMP | XNA6805 | — | — |

| Results | Shear strength (MPa) of plastic part and glass filer reinforced resin part | | 5.6 | 5.6 | 5.3 | 5.3 | 5.6 | 5.3 | — | — |
|---|---|---|---|---|---|---|---|---|---|---|
| | Glass transition temperature of impregnated resin (° C.) | | 86 | 86 | 90 | 93 | 86 | 90 | — | — |
| | Under 1.0 MPa | Radial expansion ratio R (%) at pipe center | 0.21 | 0.19 | 0.08 | 0.08 | 0.12 | 0.08 | 0.37 | 0.27 |
| | without | Entire length elongation ratio L (%) | 0.048 | 0.043 | 0.036 | 0.037 | 0.043 | 0.039 | 0.065 | 0.052 |
| | longitudinal | R/L | 4.38 | 4.42 | 2.28 | 2.22 | 2.79 | 2.10 | 5.69 | 5.19 |
| | restraint | | | | | | | | | |
| | Instantaneous | Pressure at break | ≥ 5 MPa | ≥ 5 MPa | ≥ 5 MPa | ≥ 5 MPa | ≥ 5 MPa | 4.5 Mpa | 3.6 MPa | ≥ 5 MPa |
| | destruction test | | | | | | | | | |
| | Cycle life test | Maximum pressure | 0.6 MPa | 0.6 MPa | 0.6 MPa | (1) 0.6 MPa | 1.0 MPa | 0.6 MPa | 0.6 MPa | 1.0 MPa |
| | | | | | | (2) 1.0 MPa | | | | |
| | | Number of cycle at break | ≥ 500,000 | ≥ 500,000 | ≥ 500,000 | (1) ≥ 500,000 | ≥ 500,000 | 400,000 | 200,000 | 400,000 |
| | | | | | | (2) ≥ 500,000 | | | | |
| | | Site of destruction | — | — | — | — | — | Nozzle | Columnar | Columnar |
| | | | | | | | | | part | part |

### Example 2

In Example 2, a hollow fiber membrane module was manufactured in the same procedure as that in Example 1 except that the width of an overlap of the bandage-like glass cloth was 70 mm to give an overlap ratio of the glass cloth of 70%. The pipe diameters of the center portion of the columnar part were measured with the caliper before and after an internal pressure of 1.0 MPa was applied inside the hollow fiber membrane module in Example 2 in a free state where the hollow fiber membrane module was not restrained. The change in the full length was similarly measured. The radial expansion ratio R of the center portion was 0.19%, and the full length expansion ratio L was 0.043%, giving an R/L of 4.42. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the module case was not broken under the internal pressures up to at least 5 MPa in the hollow fiber membrane module in Example 2. A cycle durability test from 0 to 0.6 MPa was carried out similarly without the hollow fiber membrane module being restrained in the longitudinal direction, and no breaking of the module was confirmed up to 500,000 cycles. After completion of the test, the hollow fiber membrane module was disassembled and no abnormalities were observed. The fiber volume content (Vf) in the glass fiber reinforced resin covering the columnar part was determined to be 38%.

### Example 3

In Example 3, covering of a glass fiber reinforced resin part of the columnar part was provided by filament winding. A glass roving used was RS 220 RL-510 (manufactured by Nitto Boseki Co., Ltd.). The main component, the curing agent, and the reaction-promoting agent used for an epoxy resin to be impregnated were XNH6805, XNR6805, and XNA6805 (all manufactured by Nagase ChemteX Corporation), respectively. A housing was secured to a filament winding apparatus manufactured by Asahi Kasei Engineering Corporation. A set of four glass rovings each weighing 18 kg was reeled out from reel stands, impregnated with the epoxy resin, and wound around the housing. The tension of the glass fibers was adjusted to about 5 N per one glass roving. The winding angle of the glass rovings was adjusted to 30° at the center of the housing. After the winding, the housing was left to stand in the environment at 80° C. for 8 hours to promote curing of the epoxy resin. The glass fiber reinforced resin parts of the headers and the nozzles were done by hand lay-up as in Example 1.

The pipe diameters of the center portion of the columnar part were measured with the caliper before and after an internal pressure of 1.0 MPa was applied inside the hollow fiber membrane module in Example 3 in a free state where the hollow fiber membrane module was not restrained. The change in the full length was similarly measured. The radial expansion ratio R of the center portion was 0.08%, the full length expansion ratio L was 0.036%, giving an R/L of 2.28. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the module case was not broken under the internal pressures up to at least 5 MPa in the hollow fiber membrane module in Example 3. A cycle durability test from 0 to 0.6 MPa was carried out similarly without the hollow fiber membrane module being restrained in the longitudinal direction, and no breaking of the module was confirmed up to 500,000 cycles. After completion of the test, the hollow fiber membrane module was disassembled and no abnormalities were observed. The fiber volume content (Vf) in the glass fiber reinforced resin covering the columnar part was determined to be 54%.

### Example 4

In Example 4, a manufacturing was carried out in the same procedure as that in Example 3 except that the material of the plastic parts of the headers and nozzles was changed to a material containing glass fibers, and that no covering with a glass fiber reinforced resin part was provided to those parts. The pipe diameters of the center portion of the columnar part were measured with the caliper before and after an internal pressure of 1.0 MPa was applied inside the hollow fiber membrane module in Example 4 in a free state where the hollow fiber membrane module was not restrained. The change in the full length was similarly measured. The radial expansion ratio R of the center portion was 0.08%, the full length expansion ratio L was 0.037%, giving an R/L of 2.22. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the module case was not broken under the internal pressures up to at least 5 MPa in the hollow fiber membrane module in Example 4. A cycle durability test from 0 to 0.6 MPa was carried out similarly without the hollow fiber membrane module being restrained in the longitudinal direction, and no breaking of the module was confirmed up to 500,000 cycles. Furthermore, the cycle durability test from 0 to 1.0 MPa was carried out using another module covered under the same conditions without the hollow fiber membrane module being restrained in the longitudinal direction, and no breaking of the module was confirmed up to 500,000 cycles. After completion of the test, the hollow fiber membrane module was disassembled and no abnormalities were observed. The fiber volume content (Vf) in the glass fiber reinforced resin covering the columnar part was determined to be 55%.

### Example 5

In Example 5, a polysulfone resin (manufactured by Solvay SA) was used as the material for a plastic part of a module case. The outer surface of the plastic part was roughened by a sand paper for improving adhesion. The surface roughness (Ra) after the roughening with a #100 sand paper was 6.6 μm. All coverings of the glass fiber reinforced resin parts were carried out by hand lay-up. A bandage-like glass cloth having a width of 50 mm (manufactured by Maeda Glass Co., Ltd. under the product name of ECM13100-A) was continuously wound around the outer circumference of the plastic part of the columnar part such that each turn of the glass cloth overlapped the adjacent turn by 30% on average. In this case, the length of warp yarns, i.e., glass fibers approximately parallel to the tubular axis of the module, was approximately 100 mm and the length of warp yarns, i.e., glass fiber approximately perpendicular to the tubular axis, was approximately 18 m. The glass cloth used was plain weave cloth in which warp and weft yarns, which were orthogonal to each other, interlaced over and under each other in alternating fashion. Thereafter, a sheet-like roving cloth (manufactured by Nitto Boseki Co., Ltd. under the product name of WF350-100BS6) was wound around the outer circumference of the wound glass cloth. A sheet-like chopped strand mat (manufactured by Nitto Boseki Co., Ltd. under the product name of MC300-A) was further wound. The average length of the glass fibers composing the chopped strand mat was 5 cm, and the glass fibers were randomly oriented in a sheet and fixed by a binder. An epoxy resin impregnation was carried out after the winding, and air was removed by pressing with a roller. Similarly, a glass cloth and a chopped strand mat were wound around the headers and the nozzles. An epoxy resin used was a blend of JER811 (manufactured by Mitsubishi Chemical Corporation) as the main component, triethylene tetramine (TETA) (manufactured by Tosoh Corporation) as the curing agent, and SR-TMP (manufactured by Sakamoto Yakuhin kogyo Co., Ltd.) as the reactive diluent. The glass cloth and the chopped strand mat were impregnated with the epoxy resin, and the workpiece was left to stand for 8 hours in the environment at 50° C. while being rotated to cure the epoxy resin, to thereby produce a hollow fiber membrane module of Example 5.

The pipe diameters of the center portion of the columnar part were measured with the caliper before and after an internal pressure of 1.0 MPa was applied inside the hollow fiber membrane module in Example 5 in a free state where the hollow fiber membrane module was not restrained. The change in the full length was similarly measured. The radial expansion ratio R of the center portion was 0.12%, and the full length expansion ratio L was 0.043%, giving an R/L of 2.79. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the module case was not broken under the internal pressures up to at least 5 MPa in the hollow fiber membrane module in Example 5. A cycle durability test from 0 to 1.0 MPa was carried out similarly without the hollow fiber membrane module being restrained in the longitudinal direction, and no breaking of the module was confirmed up to 500,000 cycles. After completion of the test, the hollow fiber membrane module was disassembled and no abnormalities were observed. The fiber volume content (Vf) in the glass fiber reinforced resin covering the columnar part was determined to be 40%.

### Example 6

In Example 6, a manufacturing was carried out in the same procedure as that in Example 4 except that the material of the plastic parts of the headers and nozzles was changed to a material containing no glass fibers, and that no covering with a glass fiber reinforced resin part was provided to those parts. The pipe diameters of the center portion of the columnar part were measured with the caliper before and after an internal pressure of 0.6 MPa was applied inside the hollow fiber membrane module in Example 6 in a free state where the hollow fiber membrane module was not restrained. The change in the full length was similarly measured. The radial expansion ratio R of the center portion was 0.08%, the full length expansion ratio L was 0.039%, giving an R/L of 2.10. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the hollow fiber membrane module in Example 6 had a leakage from a header of the module case under 4.5 MPa. A cycle durability test from 0 to 0.6 MPa was carried out similarly without the hollow fiber membrane module being restrained in the longitudinal direction, and a leakage from a nozzle of the module was confirmed after the cycle reached 400,000. The fiber volume content (Vf) in the glass fiber reinforced resin covering the columnar part was determined to be 55%.

### Comparative Example 1

In Comparative Example 1, an ABS resin (manufactured by Asahi Kasei) was used as a plastic material for the columnar part, the headers, and the nozzles. No covering with a glass fiber reinforced resin part was provided to the outer surface of a plastic part of a module case. The pipe diameters of the center portion of the columnar part were measured with the caliper before and after an internal pressure of 1.0 MPa of was applied inside the hollow fiber membrane module in Comparative Example 1 in a free state where the hollow fiber membrane module was not restrained. The change in the full length was similarly measured. The radial expansion ratio R of the center portion was 0.37%, the full length expansion ratio L was 0.065%, giving an R/L of 5.69. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, a leakage from the upper part of the columnar part occurred under 3.6 MPa in the hollow fiber membrane module of Comparative Example 1. A cycle durability test from 0 to 0.6 MPa was carried out similarly without the hollow fiber membrane module being restrained in the longitudinal direction, and a leakage from the upper part of the columnar part was confirmed at 200,000 cycles.

### Comparative Example 2

In Comparative Example 2, a polysulfone resin (manufactured by Solvay SA) was used as a plastic material for the columnar part, the headers, and the nozzles. No covering with a glass fiber reinforced resin part was provided to the outer surface of a plastic part of a module case. The pipe diameters of the center portion of the columnar part were measured with the caliper before and after an internal pressure of 1.0 MPa was applied inside the hollow fiber membrane module in Comparative Example 2 in a free state where the hollow fiber membrane module was not restrained. The change in the full length was similarly measured. The radial expansion ratio R of the center portion was 0.27%, the full length expansion ratio L was 0.052%, giving an R/L of 5.19. Subsequently, an instantaneous destruction test was carried out without the hollow fiber membrane module being restrained in the longitudinal direction. The test results are summarized in Table 1, along with the materials and dimensions of the plastic parts, the glass fiber reinforced resin parts, the hollow fiber membranes, and the potting material. As summarized in Table 1, the module case was not broken under the internal pressures up to at least 5 MPa in the hollow fiber membrane module in Comparative Example 2. A cycle durability test from 0 to 1.0 MPa was carried out similarly without the hollow fiber membrane module being restrained in the longitudinal direction, and a leakage from the upper part of the columnar part was confirmed at 400,000 cycles.

### REFERENCE SIGNS LIST

10 Hollow fiber membrane module

11 Hollow fiber membrane

12 Potting material

13 Module case

14 Housing main body

15 Cap

16 Columnar part

17 Header

18 Nozzle

19 Nut

20 O-ring

21 Tubular tract

22 Plastic part

23 Glass fiber reinforced resin part

24 Glass fiber

25 Fabric body of glass fibers

26 Flow guide cylinder

27 Glass cloth for nozzle

28 Pre-cut glass cloth

41 System for producing ultra-pure water

42 Feed pipe

43 Discharge pipe

44 Filtrate pipe

1. A method of a filtration by using a hollow fiber membrane module comprising a module case; and a hollow fiber membrane bundle comprising a plurality of hollow fiber membranes bundled together and being accommodated in the module case, respective ends of the hollow fiber membranes being bonded together by a potting material, the filtration being carried out under a pressure inside the hollow fiber membrane module of 0.3 to 1.2 MPa,
wherein the hollow fiber membrane module satisfies a relationship: 0.5<R/L<5 when the pressure inside the hollow fiber membrane module is 1.0 MPa without the hollow fiber membrane module being restrained, and
the hollow fiber membrane module satisfies relationships: 0<R<0.25 and 0<L<0.06 during an operation, where R (%) represents a radial expansion ratio at a center portion in a longitudinal direction, and L (%) represents a longitudinal expansion ratio, of the hollow fiber membrane module.

2. A method of desalinating sea water by using a hollow fiber membrane module comprising a module case; and a hollow fiber membrane bundle comprising a plurality of hollow fiber membranes bundled together and being accommodated in the module case, respective ends of the hollow fiber membranes being bonded together by a potting material, under a pressure inside the hollow fiber membrane module of 0.3 to 1.2 MPa, the method comprising:
a filtration step of filtrating the sea water through the hollow fiber membrane module; and
a desalting step of desalting a filtrate from the filtration step, through a reverse osmosis membrane directly connected to the hollow fiber membrane module, under a pressure higher than a pressure in the filtration step,
wherein the hollow fiber membrane module satisfies a relationship: 0.5<R/L<5 when the pressure inside the hollow fiber membrane module is 1.0 MPa without the hollow fiber membrane module being restrained, and
the hollow fiber membrane module satisfies relationships: 0<R<0.25 and 0<L<0.06 during an operation in an operation condition, where R (%) represents a radial expansion ratio at a center portion in a longitudinal direction, and L (%) represents a longitudinal expansion ratio, of the hollow fiber membrane module.

3. A method of producing fresh water by using a hollow fiber membrane module comprising a module case; and a hollow fiber membrane bundle comprising a plurality of hollow fiber membranes bundled together and being accommodated in the module case, respective ends of the hollow fiber membranes being bonded together by a potting material, under a pressure inside the hollow fiber membrane module of 0.3 to 1.2 MPa, the method comprising:
a filtration step of filtrating a raw liquid through the hollow fiber membrane module; and
a desalting step of desalting a filtrate from the filtration step, through a reverse osmosis membrane directly connected to the hollow fiber membrane module, under a pressure higher than a pressure in the filtration step,
wherein the hollow fiber membrane module satisfies a relationship: 0.5<R/L<5 when the pressure inside the hollow fiber membrane module is 1.0 MPa without the hollow fiber membrane module being restrained, and
the hollow fiber membrane module satisfies relationships: 0<R<0.25 and 0<L<0.06 during an operation in an operation condition, where R (%) represents a radial expansion ratio at a center portion in a longitudinal direction, and L (%) represents a longitudinal expansion ratio, of the hollow fiber membrane module.

4. The method of filtration of claim 1, comprising a filtration step of feeding a raw water at 70° C. or higher and 80° C. or lower to outer surface sides of the hollow fiber membranes, with a differential pressure across the membranes of 0.3 MPa at maximum under a pressure of 0.8 MPa at maximum, to extract a filtrate from inner surface sides of the hollow fiber membranes under a pressure of 0.8 MPa at maximum.

5. The method of filtration of claim 1, comprising a filtration step of feeding the raw water at 20° C. or higher and 30° C. or lower to the outer surface sides of the hollow fiber membranes, with a differential pressure across the membranes of 0.3 MPa at maximum under a pressure of 1.2 MPa at maximum, to extract the filtrate under a pressure of 1.2 MPa at maximum.

6. A hollow fiber membrane module comprising: a module case; and
a hollow fiber membrane bundle comprising a plurality of hollow fiber membranes bundled together and being accommodated in the module case, respective ends of the hollow fiber membranes being bonded together by a potting material,
wherein the hollow fiber membrane module satisfies a relationship: 0.5<R/L<5 when the pressure inside the hollow fiber membrane module is 1.0 MPa without the hollow fiber membrane module being restrained, and
the hollow fiber membrane module satisfies relationships: 0<R<0.25 and 0<L<0.06 during an operation, where R (%) represents a radial expansion ratio at a center portion in a longitudinal direction, and L (%) represents a longitudinal expansion ratio, of the hollow fiber membrane module.

7. The hollow fiber membrane module according to claim 6, wherein the module case comprises:
a header made of a plastic material containing glass short fibers; and
a columnar part comprising an inner layer of a plastic part and an outer layer of a glass fiber reinforced resin part containing glass long fibers, the glass long fibers being wound in the glass fiber reinforced resin part at an angle of 60° to 120° relative to a tubular axial direction of the module case.

8. The hollow fiber membrane module according to claim 6, wherein at least a part of the module case comprises a layer of a glass fiber reinforced resin part on an outer surface side thereof, and a ratio of a thickness of the layer of the glass fiber reinforced resin part to a wall thickness of the module case is 5% or more and 50% or less, in at least a part of the module case provided with the glass fiber reinforced resin part.

9. The hollow fiber membrane module according to claim 6, wherein
at least a part of the module case includes at least one of a glass cloth, a roving cloth, and a chopped strand mat, and
a weight per square meter of the at least one of the glass cloth, the roving cloth, and the chopped strand mat is 50 g or more and 600 g or less.

10. The hollow fiber membrane module according to claim 8, wherein the glass fiber reinforced resin part comprises a first glass fiber reinforced resin part covering a columnar part, a second glass fiber reinforced resin part covering a header, and a third glass fiber reinforced resin part covering a nozzle,
a region in which glass fibers in the first glass fiber reinforced resin part and glass fibers in the second glass fiber reinforced resin part overlap one another, and
a region in which glass fibers in the second glass fiber reinforced resin part and glass fibers in the third glass fiber reinforced resin part overlap one another.

11. The hollow fiber membrane module according to claim 10, wherein a weight per square meter of the at least one of the glass cloth, the roving cloth, and the chopped strand mat of the glass fibers used in the third glass fiber reinforced resin part is 50 g or more and 300 g or less.

12. The hollow fiber membrane module according to claim 8, wherein the glass fiber reinforced resin part is laminated on an outer surface side of the plastic part in the module case, and
a tensile shear strength of the glass fiber reinforced resin part and the plastic part is 3 MPa or more.

13. The hollow fiber membrane module according to claim 8, wherein
the at least one of the glass cloth, the roving cloth, and the chopped strand mat containing the glass fibers in the glass fiber reinforced resin part is wound spirally in the module case, and
a width of the at least one of the glass cloth, the roving cloth, and the chopped strand mat is 30 mm or more and 140 mm or less.

14. A sea water desalination system comprising:
the hollow fiber membrane module according to claim 6, configured to filtrate sea water; and
a reverse osmosis membrane module configured to desalt a filtrate from the hollow fiber membrane module, the hollow fiber membrane module and the reverse osmosis membrane module being directly connected or being connected having a pump interposed therebetween.
